(19) United States
(12) Patent Application Publication
(10) Pub. No.: US 2023/0385631 A1
(43) Pub. Date: Nov. 30, 2023

(54) METHOD AND SYSTEM FOR CONSTRUCTING NEURAL NETWORK ARCHITECTURE SEARCH FRAMEWORK, DEVICE, AND MEDIUM

(71) Applicant: INSPUR SUZHOU INTELLIGENT TECHNOLOGY CO., LTD., Suzhou, Jiangsu (CN)

(72) Inventors: Zhenzhen ZHOU, Suzhou, Jiangsu (CN); Feng LI, Suzhou, Jiangsu (CN); Xiaolan ZHANG, Suzhou, Jiangsu (CN)

(21) Appl. No.: 18/022,985

(22) PCT Filed: Sep. 30, 2021
(86) PCT No.: PCT/CN2021/122255

§ 371 Date: Feb. 23, 2023

(30) Foreign Application Priority Data
Dec. 17, 2020 (CN) 202011495125.8

(51) Int. Cl. G06N 3/08; G06N 3/04

(52) U.S. Cl. CPC G06N 3/08; G06N 3/04

(57) ABSTRACT

The method includes: generating an initial super-network structure in a super-network class according to a search space configuration file, and pre-training a super-network in the initial super-network structure by using a data set (S1); sampling a sub-network in the pre-trained super-network by using a controller, and setting corresponding head network and neck network in the sub-network according to a task type to form a sub-task network (S2); training the sub-task network, and updating the initial super-network structure according to a training result to obtain the super-network structure (S3); and verifying the super-network structure based on a plurality of sub-task networks, and optimizing the super-network and the controller by using verification results, and repeating the processes of the controller of sampling, verifying and optimizing until the time of repetitions reaches a threshold, and selecting the super-network structure with an optimal verification result as the search framework of the neural network architecture (S4).

### CROSS-REFERENCE TO RELATED APPLICATION

The present disclosure claims the priority of the Chinese patent application filed on Dec. 17, 2020 before the CNIPA, China National Intellectual Property Administration with the application number of 202011495125.8 and the title of “METHOD AND SYSTEM FOR CONSTRUCTING NEURAL NETWORK ARCHITECTURE SEARCH FRAMEWORK, DEVICE, AND MEDIUM”, which is incorporated herein in its entirety by reference.

### FIELD

The present disclosure relates to the technical field of neural network and, more particularly, relates to a method and system for constructing a search framework of a neural network architecture, a computer device, and a non-volatile computer-readable storage medium.

### BACKGROUND

With the continuous development of deep learning technology, the number of layers of neural network is increasing. As of 2016, the deepest neural network has over 1000 layers. Designing the neural network by artificial requires a lot of experiments, and requires rice knowledge reserve and personal experience to practitioners. The repeated experimental process seriously restricts the work efficiency of relevant persons.

In this context, auto deep learning (AutoDL) technology came into being. There are mainly an AutoDL based on reinforcement learning, an AutoDL based on evolutionary algorithm or gradient-based methods. The AutoDL based on reinforcement learning is mainly realized by obtaining a maximum reward in the process of interaction between the neural network architecture search (NAS) framework and the environment. The main representative algorithms are NASNet, MetaQNN, BlockQNN, etc. The AutoDL based on evolutionary algorithm is mainly to use the NAS to simulate the laws of biological heredity and evolution, which is realized by evolutionary algorithm, and the main representative algorithms are AmoabaNet, NEAT (Neuroevolution of augmenting topologies, enhanced topological neural network), DeepNEAT, CoDeepNEAT, etc. The gradient-based method mainly regards the objective function of the search process as an optimization process in a continuous space and turns the objective function to a differentiable function to implement. The main representative algorithms are Differentiable Architecture Search (DARTS), P-DARTS, etc.

At present, there are many kinds of NAS networks, and the algorithms in computer vision tasks such as image classification, object detection and image segmentation are constantly updated. However, the lack of a general algorithm in different fields causes difficulties for users in different fields. Secondly, the network architecture searched by the current NAS method and its accuracy effect after final training are greatly affected by different data sets, and it is difficult to transfer and generalize the model. In addition, the network architecture obtained by searching for different tasks cannot be reused, which is undoubtedly a great waste of searching time and leads to a significant reduction in the work efficiency of practitioners.

### SUMMARY

In some embodiments, the present application discloses a method for constructing a search framework of a neural network architecture, including: generating an initial super-network structure in a super-network class according to a search space configuration file, and pre-training a super-network in the initial super-network structure by using a data set; sampling a sub-network in the pre-trained super-network by using a controller, and setting corresponding head network and neck network in the sub-network according to a task type to form a sub-task network; training the sub-task network, and updating the initial super-network structure according to a training result to obtain the super-network structure; and verifying the super-network structure based on a plurality of sub-task networks, and optimizing the super-network and the controller by using verification results, and repeating the processes of the controller of sampling, verifying and optimizing until the time of repetitions reaches a threshold, and selecting the super-network structure with an optimal verification result as the search framework of the neural network architecture.

In some embodiments, the step of verifying the super-network structure based on the plurality of sub-task networks includes: sampling the plurality of sub-task networks, and stacking the plurality of sub-task networks according to a preset stacking mode to generate a backup network set, and verifying the super-network structure by using the backup network set.

In some embodiments, the method for constructing a search framework of the neural network architecture further includes: determining a process of training the sub-task network is interrupted by an interrupt event, reading the super-network structure and parameters according to a preset address, and recovering a super-network weight and a number of training iterations.

In some embodiments, the step of training the sub-task network includes: detecting whether a data dimension of input data is consistent with a preset input dimension, and detecting whether a data dimension of output data corresponding to the input data is consistent with a preset output dimension; and in responding to that the data dimension of the input data is inconsistent with the preset input dimension and/or the data dimension of the output data corresponding to the input data is inconsistent with the preset output dimension, and interrupting training of the sub-task network.

In some embodiments, the present application further discloses a system for constructing a search framework of a neural network architecture, including: an initial module configured for generating an initial super-network structure in a super-network class according to a search space configuration file, and pre-training a super-network in the initial super-network structure by using a data set; a sampling module configured for sampling a sub-network in the pre-trained super-network by using a controller, and setting corresponding head network and neck network in the sub-network according to a task type to form a sub-task network; a training module configured for training the sub-task network, and updating the initial super-network structure according to a training result to obtain the super-network structure; and a verifying module configured for verifying the super-network structure based on a plurality of sub-task networks, and optimizing the super-network and the controller by using verification results, and repeating the processes of the controller of sampling, verifying and optimizing until reaching a super-network structure with an optimal verification result.

In some embodiments, the verifying module is configured for: sampling the plurality of sub-task networks, and stacking the plurality of sub-task networks according to a preset stacking mode to generate a backup network set, and verifying the super-network structure by using the backup network set.

In some embodiments, the system further includes a recovering module which is configured for: determining a process of training the sub-task network is interrupted by an interrupt event, reading the super-network structure and parameters according to a preset address, and recovering a super-network weight and a number of training iterations.

In some embodiments, the training module is configured for: detecting whether a data dimension of input data is consistent with a preset input dimension, and detecting whether a data dimension of output data corresponding to the input data is consistent with a preset output dimension; and in responding to that the data dimension of the input data is inconsistent with the preset input dimension and/or the data dimension of the output data corresponding to the input data is inconsistent with the preset output dimension, and interrupting training of the sub-task network.

In some embodiments, the present application discloses a computer device, including:
a memory storing computer-readable instructions therein; and
one or more processor configured for, when executing the computer-readable instructions, implementing operations including:
   generating an initial super-network structure in a super-network class according to a search space configuration file, and pre-training a super-network in the initial super-network structure by using a data set;
   sampling a sub-network in the pre-trained super-network by using a controller, and setting corresponding head network and neck network in the sub-network according to a task type to form a sub-task network;
   training the sub-task network, and updating the initial super-network structure according to a training result to obtain the super-network structure; and
   verifying the super-network structure based on a plurality of sub-task networks, and optimizing the super-network and the controller by using verification results, and repeating the processes of the controller of sampling, verifying and optimizing until the time of repetitions reaches a threshold, and selecting the super-network structure with an optimal verification result as the search framework of the neural network architecture.

In some embodiments, the present application discloses one or more non-volatile computer-readable storage medium storing a computer-readable instruction, when the computer-readable instruction is executed by one or more processor, causing the processor to implement operations including:
generating an initial super-network structure in a super-network class according to a search space configuration file, and pre-training a super-network in the initial super-network structure by using a data set;
sampling a sub-network in the pre-trained super-network by using a controller, and setting corresponding head network and neck network in the sub-network according to a task type to form a sub-task network;
training the sub-task network, and updating the initial super-network structure according to a training result to obtain the super-network structure; and
verifying the super-network structure based on a plurality of sub-task networks, and optimizing the super-network and the controller by using verification results, and repeating the processes of the controller of sampling, verifying and optimizing until the time of repetitions reaches a threshold, and selecting the super-network structure with an optimal verification result as the search framework of the neural network architecture.

### BRIEF DESCRIPTION OF THE DRAWINGS

In order to more clearly explain the technical solution in the embodiments of the present application or traditional technology, the following will briefly introduce the drawings needed in the embodiments or traditional technology. Obviously, the drawings in the following description are only some embodiments of the present application, and those of ordinary skill in the art may obtain other embodiments based on these drawings without involving any inventive effort.

FIG. 1 is a schematic diagram of a method for constructing a search framework of a neural network architecture in some embodiments;

FIG. 2 is a flow chart of training the super-network in some embodiments;

FIG. 3 is a flow chart of generating an alternative network in some embodiments; and

FIG. 4 is a schematic diagram showing the hardware structure of the computer device for constructing a search framework of a neural network architecture in some embodiments.

### DETAILED DESCRIPTION

In order to make the objective, technical solution and advantages of the present application clearer, the embodiments of the present application are further described in detail by combining the embodiments and referring the drawings.

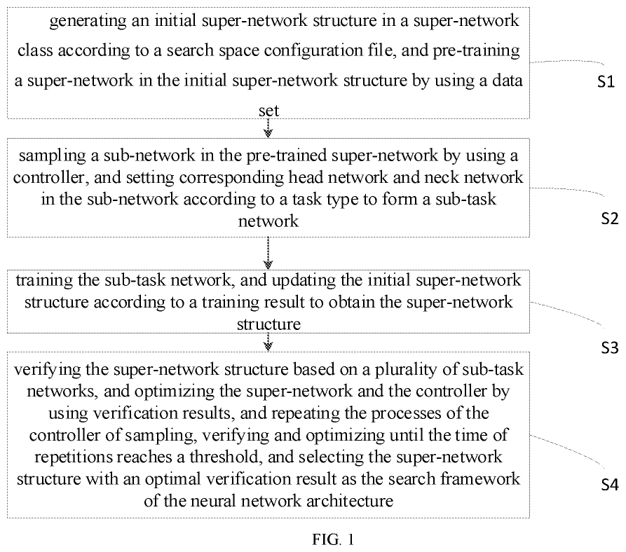

FIG. 1 shows a schematic diagram of a method for constructing a search framework of a neural network architecture in some embodiments. As shown in FIG. 1, the method for constructing the search framework of the neural network architecture includes the steps as follows:

S1: generating an initial super-network structure in a super-network class according to a search space configuration file, and pre-training a super-network in the initial super-network structure by using a data set;

S2: sampling a sub-network in the pre-trained super-network by using a controller, and setting corresponding head network and neck network in the sub-network according to a task type to form a sub-task network;

S3: training the sub-task network, and updating the initial super-network structure according to a training result to obtain the super-network structure; and

S4: verifying the super-network structure based on a plurality of sub-task networks, and optimizing the super-network and the controller by using verification results, and repeating the processes of the controller of sampling, verifying and optimizing until the time of repetitions reaches a threshold, and selecting the super-network structure with an optimal verification result as the search framework of the neural network architecture.

When implementing method for constructing a search framework of a neural network architecture, different sub-task networks are set according to different task types, and train the sub-task networks are trained so that the search framework of the neural network architecture may be applied to different scenarios and have better data migration ability between data sets. Compared with other neural network construction methods, the method of the present disclosure has strong realizability, and the training process may continue after being interrupted, and it has a strong fault tolerance space.

An initial super-network structure is generated in a super-network class according to a search space configuration file, and a super-network in the initial super-network structure is pre-trained by using a data set. The construction of the super-network structure may adopt the microscopic search method. A basic cell (unit) is obtained by searching, and by changing the stacking structure of the cell, the construction of the network is realized. The search space inside the cell contains 6 alternative operations including no operation (identity), convolution, dilated convolution, average pooling, max pooling and depthwise-separable convolution. The super-network may be pre-trained by using an ImageNet (a computer vision system recognition project) data set, the weight may be saved as the initial weight when the subsequent super-network is constructed.

The sub-network is sampled in the pre-trained super-network by using a controller, and the corresponding head network and neck network are set in the sub-network according to the task type to form the sub-task network. The sub-task network is trained and the initial super-network structure is updated according to the training results to obtain the super-network structure.

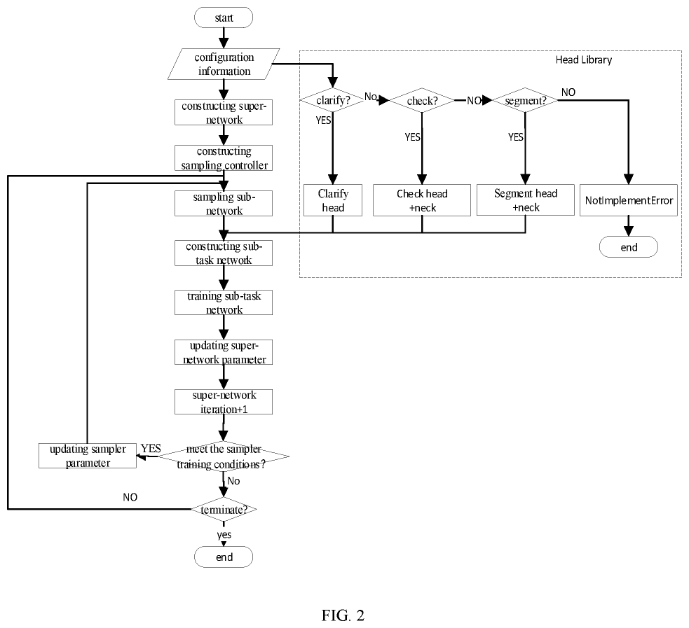

FIG. 2 is a flow chart of training the super-network. As shown in FIG. 2, after receiving the configuration information filled by the user, the required head and neck are selected according to the configuration information task type. According to the default configuration information, the super-network and a sampling controller are generated. The sampling controller samples a cell structure from the super-network, and splices with the previously selected head network to form the sub-task network. The head network is frozen, and the sub-task network only does one epoch training, that is, all the data in the training set is used to conduct a complete training of the model, and the parameters of the cell are shared with the corresponding parameters in the super-network. The sampled sub-network and the corresponding verification set accuracy are recorded. After the sub-network of the assigned batch is sampled, the sampling controller is updated according to the sub-network and accuracy. For the detection task, the value of (1/loss) in the verification set is recorded as the reward to update the sampling controller.

The sampler class is realized by the recurrent neural network (RNN) controller, which contains N nodes, and each node contains 4 kinds of activation functions, including tanh/ReLU/identity/sigmoid. Among them, the i-th (i>1) node may be connected to the input or any node before the i-th node, there are totally i connection methods, and so on, the number of the kinds of the directed graph connection methods of N nodes to the activation function are totally 4N×N!.

The process of selecting head network and neck network may include: firstly, whether the task type is classification is determined, if yes, classifying head network is set. If not, then whether the task type is detection is determined, if yes, detecting the head network and the neck network are set. If not, whether the task type is splicing is determined, if yes, the splicing head network and neck network are set. If not, reporting error may be performed.

The construction methods of different head networks are as follows:

The head network of the image classification task generates the corresponding classifier according to the number of categories that the user needs to classify. Taking cifar10 (a small data set for identifying universal objects organized by the Alex Krizhevsky and the Ilya Sutskever) as an example, the image classification network may be composed of backbone network, flatten layer, dense (full connection) layer, dropout layer, etc. When applied on different data sets, the dense layer structure needs to be modified according to user classification.

The target detection task needs to add the corresponding neck network and the corresponding head network to complete the network task of target positioning and output category. Taking ImageNet as an example, use the feature pyramid network (FPN) is used as the neck network, and the combination of the region of interest (ROI) pooling layer, the region proposal network (RPN) and ROI head is used as the head network. In other embodiments, the neck and head may also be implemented using other networks.

The image segmentation task needs to add the corresponding neck network and the corresponding head network. Unlike the target detection, the head network of the image segmentation task should output the image mask. In an embodiment, the FPN is used as the neck network, the combination of the ROI Align layer, RPN and the full connection layer is used as a segmentation head network.

The super-network structure is verified, and in response to successful verification, the super-network structure is used as the final search framework of a neural network architecture.

In some embodiments, the step of verifying the super-network structure includes: sampling the plurality of sub-task networks, and stacking the plurality of sub-task networks according to a preset stacking mode to generate a backup network set, and verifying the super-network structure by using the backup network set.

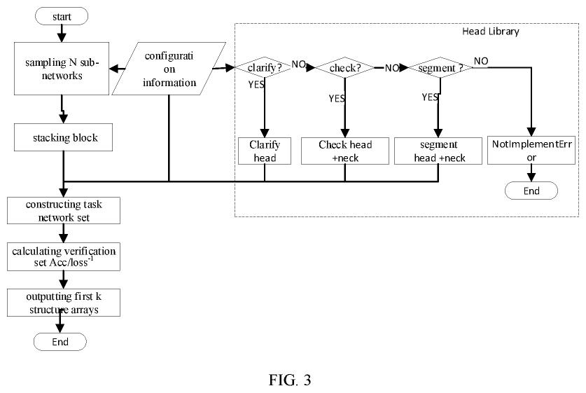

FIG. 3 is a flow chart of generating an alternative network. As shown in FIG. 3, after the training of the super-network and the sampler are completed, the head network and neck network of the corresponding task are selected according to the user settings. The sampler samples N cell structures in the super-network, each cell is stacked according to the preset stacking method, and then spliced with the head/neck network to generate N task networks. The verification set data is input into N task networks respectively, the accuracy is calculated, and the verification set Acc/loss⁻¹ is calculated for the detection task, that is, the value of Acc or (1/loss) of the verification set is calculated for the detection task, wherein Acc refers to the accuracy of the verification set, loss refers to the loss value of the verification set; the structure array of the first k task networks is output as a backup network set. In the process of alternative network generating, all parameters are fixed, and the network is not trained.

In order to avoid the occurrence of an interrupt event in the training process which leads to the need to re-conduct the training, in some embodiments, the method for constructing the search framework of the neural network architecture further includes the steps of saving progress and recovering progress.

The step of progress saving includes: outputting search configuration information, search task information, and result information to the result folder in the form of a report; receiving the instance of the model saving class (e.g. model_saver), passing the super-network into the instance and saving it according to the settings; passing the backup network set generated after completing running to the instance of the model saving class for saving; when the program is abnormally interrupted, the log record and the model saving method are called to record the progress.

The step of recovering progress includes: according to user settings, reading the super-network according to the given address to realize the recovery of super-network training progress; for the exp (experiment, which may be understood as “experiment” or “process”) that has finished super-network training, prompting to restore the super-network or restore the backup network set, and restore the corresponding network parameters.

In some embodiments, the method for constructing a search framework of a neural network architecture further includes: in response to an interruption, whether to complete the training of the sub-task network is determined; in response to incomplete training of the sub-task network, the super-network structure and parameters are read according to the preset address, and the super-network weight and the number of training iterations are recovered. If super-network training is not completed, the super-network structure and parameters are read according to the address in the configuration, and the super-network weight and the number of training iterations are recovered. If the super-network training has been completed, the backup network set array and the corresponding performance indicators are read according to the address in the configuration, and the backup network set is output. The aforementioned step of in response to an interruption, whether to complete the training of the sub-task network is determined refers to: after the program terminates unexpectedly, it is determined whether to complete the training of the sub-task network. The aforementioned in response to incomplete training of the sub-task network, the super-network structure and parameters are read according to the preset address, and the super-network weight and the number of training iterations are recovered refers to: if it is determined that the training of the sub-task network has not been completed, that is, the program of the sub-task network training is determined to be interrupted by an interrupt event, then the super-network structure and parameters are read according to the preset address, and the super-network weight and the number of training iterations are recovered. The aforementioned preset address refers to the address in the configuration.

In addition, the embodiment of the present application supports users to set search performance requirements, including:
Setting the time limit (maxExecDuration) which is used to complete search network tasks, training tasks, and model scaling tasks within a fixed time range;
Setting the parameter limit (maxParams), which is used to limit the parameter amount of the output model.

In some embodiments, the step of training the sub-task network includes: detecting whether a data dimension of input data is consistent with a preset input dimension, and detecting whether a data dimension of output data corresponding to the input data is consistent with a preset output dimension; and in responding to that the data dimension of the input data is inconsistent with the preset input dimension and/or the data dimension of the output data corresponding to the input data is inconsistent with the preset output dimension, and interrupting training of the sub-task network.

The method for constructing a search framework of a neural network architecture further includes a fault-tolerant step, and the fault-tolerant step includes:

1. Scale Calibration Settings

PreCheck (pre-check): determining whether the data dimension is consistent with the input dimension of the model construction before inputting data; PosCheck (post-check): selecting a data sample input model before inputting data, and verifying whether the output is consistent with the assigned dimension; SamplerCheck (sampler check): determining whether the output generated by a sampler is within the sampling space before inputting data. If the above checks are inconsistent, the program will throw an exception and terminate.

2. Checkpoint Reading

In the super-network training process, the model_saver object is continuously updated, and the model_saver object saves checkpoints according to the time interval set by the user, so as to recover training when abnormal interruption occurs. The main process of stage information updates the corresponding content of the logger (e.g.: logger.autonas_log.update(**autonas_prams)), and the protection process saves logs/prints to the screen according to the strategy of the logger. After the super-network is completely trained and the backup network set is searched out, the backup network set is saved for subsequent selection of the optimal network.

The classes and the attributes (a part) and methods (a part) in the classes included in the embodiment of the present application are as follows:
StackLSTMCell: implementing the basic cell of lstm, which is used to form a sampler;
Sampler: inherited from Mutator, which is used to implement sampler, and sample from super-network;
SuperNet: inherited from nn.Module, which defines the search space scale and selectable operations of nodes, the Reload parameter indicates whether to overload the super-network weight;
HeadLib: inherited from nn.Module, which is used to implement head network for two different tasks of classification and detection;
SubNet: relying on out_node in SuperNet and HeadLib, which is used to realize the network structure of cell+head;
TaskNet: relying on out_node in SuperNet and HeadLib, which is used to realize the network structure of +head after cell stacking;
Trainer: trainer, including the definition of the training method for the super-network and the training method for the sampler.

It should be pointed out that the steps in the embodiments of the above-mentioned method for constructing a search framework of a neural network architecture may intersect, replace, increase, and delete each other. Therefore, the reasonable arrangement, combination and transformation of the method for constructing a search framework of a neural network architecture should also fall within the protection scope of the present application, and the protection scope of the present application shall not be limited to embodiments.

The present application discloses a system for constructing a search framework of a neural network architecture, including: an initial module configured for generating an initial super-network structure in a super-network class according to a search space configuration file, and pre-training a super-network in the initial super-network structure by using a data set; a sampling module configured for sampling a sub-network in the pre-trained super-network by using a controller, and setting corresponding head network and neck network in the sub-network according to a task type to form a sub-task network; a training module configured for training the sub-task network, and updating the initial super-network structure according to a training result to obtain the super-network structure; and a verifying module configured for verifying the super-network structure based on a plurality of sub-task networks, and optimizing the super-network and the controller by using verification results, and repeating the processes of the controller of sampling, verifying and optimizing until reaching a super-network structure with an optimal verification result.

In some embodiments, the verifying module is configured for: sampling the plurality of sub-task networks, and stacking the plurality of sub-task networks according to a preset stacking mode to generate a backup network set, and verifying the super-network structure by using the backup network set.

In some embodiments, the system for constructing a search framework of a neural network architecture further includes a recovering module, and the recovering module is configured for: in response to an interruption, whether to complete the training of the sub-task network is determined; and in response to incomplete training of the sub-task network, the super-network structure and parameters are read according to the preset address, and the super-network weight and the number of training iterations are recovered. The aforementioned step of in response to an interruption, whether to complete the training of the sub-task network is determined refers to: after the program terminates unexpectedly, it is determined whether to complete the training of the sub-task network. The aforementioned in response to incomplete training of the sub-task network, the super-network structure and parameters are read according to the preset address, and the super-network weight and the number of training iterations are recovered refers to: if it is determined that the training of the sub-task network has not been completed, that is, the program of the sub-task network training is determined to be interrupted by an interrupt event, then the super-network structure and parameters are read according to the preset address, and the super-network weight and the number of training iterations are recovered. The aforementioned preset address refers to the address in the configuration.

In some embodiments, the training module is configured for: detecting whether a data dimension of input data is consistent with a preset input dimension, and detecting whether a data dimension of output data corresponding to the input data is consistent with a preset output dimension; and in responding to that the data dimension of the input data is inconsistent with the preset input dimension and/or the data dimension of the output data corresponding to the input data is inconsistent with the preset output dimension, and interrupting training of the sub-task network.

In some embodiments, the present application discloses a computer device, including:
a memory storing computer-readable instructions therein; and
one or more processor configured for, when executing the computer-readable instructions, implementing operations including:
   generating an initial super-network structure in a super-network class according to a search space configuration file, and pre-training a super-network in the initial super-network structure by using a data set;
   sampling a sub-network in the pre-trained super-network by using a controller, and setting corresponding head network and neck network in the sub-network according to a task type to form a sub-task network;
   training the sub-task network, and updating the initial super-network structure according to a training result to obtain the super-network structure; and
   verifying the super-network structure based on a plurality of sub-task networks, and optimizing the super-network and the controller by using verification results, and repeating the processes of the controller of sampling, verifying and optimizing until the time of repetitions reaches a threshold, and selecting the super-network structure with an optimal verification result as the search framework of the neural network architecture.

In some embodiments, that when the processors execute the computer-readable instructions, the operation of verifying the super-network structure based on the plurality of sub-task networks is implemented includes: sampling the plurality of sub-task networks, and stacking the plurality of sub-task networks according to a preset stacking mode to generate a backup network set, and verifying the super-network structure by using the backup network set.

In some embodiments, when the processors execute the computer-readable instructions, the operations are further implemented as follows: in response to an interruption, whether to complete the training of the sub-task network is determined; and in response to incomplete training of the sub-task network, the super-network structure and parameters are read according to the preset address, and the super-network weight and the number of training iterations are recovered. The aforementioned step of in response to an interruption, whether to complete the training of the sub-task network is determined refers to: after the program terminates unexpectedly, it is determined whether to complete the training of the sub-task network. The aforementioned in response to incomplete training of the sub-task network, the super-network structure and parameters are read according to the preset address, and the super-network weight and the number of training iterations are recovered refers to: if it is determined that the training of the sub-task network has not been completed, that is, the program of the sub-task network training is determined to be interrupted by an interrupt event, then the super-network structure and parameters are read according to the preset address, and the super-network weight and the number of training iterations are recovered. The aforementioned preset address refers to the address in the configuration.

In some embodiments, that when the processors execute the computer-readable instructions, the operation of training the sub-task network is implemented includes: detecting whether a data dimension of input data is consistent with a preset input dimension, and detecting whether a data dimension of output data corresponding to the input data is consistent with a preset output dimension; and in responding to that the data dimension of the input data is inconsistent with the preset input dimension and/or the data dimension of the output data corresponding to the input data is inconsistent with the preset output dimension, and interrupting training of the sub-task network.

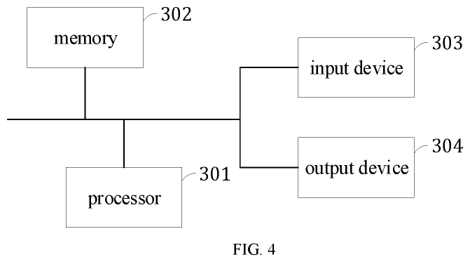

FIG. 4 is a schematic diagram showing the hardware structure of the computer device for constructing a search framework of a neural network architecture in some embodiments.

Taking the computer device shown in FIG. 4 as an example, the computer device includes a processor 301 and a memory 302, and may also include: an input device 303 and an output device 304.

The processor 301, the memory 302, the input device 303 and the output device 304 may be connected by bus or other means. In FIG. 4, the connection by the bus is taken as an example.

As a non-volatile computer-readable storage medium, the memory 302 may be used to store non-volatile software programs, non-volatile computer executable programs and modules, such as the program instructions/modules corresponding to the method for constructing a search framework of a neural network architecture in the embodiment of the present application. Processor 301 performs various functional applications and data processing of the server by running non-volatile software programs, instructions, and modules stored in the memory 302, that is, the method for constructing the search framework of the neural network architecture of the above method embodiments is implemented.

The memory 302 may include a storage program area and a storage data area, wherein the storage program area may store the operating system and at least one application required for the function. The storage data area may store the data created according to the usage of the method for constructing the search framework of the neural network architecture. In addition, the memory 302 may include a high-speed random access memory and may also include a non-volatile memory, such as at least one disk memory device, flash memory device, or other non-volatile solid-state memory device. In some embodiments, the memory 302 may include memory that is remotely set relative to the processor 301, and these remote memories may be connected to the local module over the network. Embodiments of the above networks include but are not limited to the Internet, enterprise intranets, local area networks, mobile communication networks and their combinations.

The input device 303 may receive input information such as user name and password. The output device 304 may include a display device such as a display screen.

The program instructions/modules corresponding to one or more methods of constructing the search framework of the neural network architecture are stored in memory 302. When executed by the processor 301, the method for constructing the search framework of the neural network architecture in any of the above method embodiments is executed.

Any embodiment of a computer device that executes the method for constructing the search framework of the neural network architecture may achieve the same or similar effect as any one of the corresponding method embodiments of constructing the search framework of the neural network architecture.

The present application further discloses one or more non-volatile computer-readable storage medium storing a computer-readable instruction, when the computer-readable instruction is executed by one or more processor, causing the processor to implement operations including:
generating an initial super-network structure in a super-network class according to a search space configuration file, and pre-training a super-network in the initial super-network structure by using a data set;
sampling a sub-network in the pre-trained super-network by using a controller, and setting corresponding head network and neck network in the sub-network according to a task type to form a sub-task network;
training the sub-task network, and updating the initial super-network structure according to a training result to obtain the super-network structure; and
verifying the super-network structure based on a plurality of sub-task networks, and optimizing the super-network and the controller by using verification results, and repeating the processes of the controller of sampling, verifying and optimizing until the time of repetitions reaches a threshold, and selecting the super-network structure with an optimal verification result as the search framework of the neural network architecture.

In some embodiments, that when the computer-readable instruction is executed by one or more processor, the operation of verifying the super-network structure based on the plurality of sub-task networks is implemented includes:
sampling the plurality of sub-task networks, and stacking the plurality of sub-task networks according to a preset stacking mode to generate a backup network set, and verifying the super-network structure by using the backup network set.

In some embodiments, when the computer-readable instruction is executed by one or more processor, the operations are further implemented as follows: in response to an interruption, whether to complete the training of the sub-task network is determined; and

in response to incomplete training of the sub-task network, the super-network structure and parameters are read according to the preset address, and the super-network weight and the number of training iterations are recovered. The aforementioned step of in response to an interruption, whether to complete the training of the sub-task network is determined refers to: after the program terminates unexpectedly, it is determined whether to complete the training of the sub-task network. The aforementioned in response to incomplete training of the sub-task network, the super-network structure and parameters are read according to the preset address, and the super-network weight and the number of training iterations are recovered refers to: if it is determined that the training of the sub-task network has not been completed, that is, the program of the sub-task network training is determined to be interrupted by an interrupt event, then the super-network structure and parameters are read according to the preset address, and the super-network weight and the number of training iterations are recovered. The aforementioned preset address refers to the address in the configuration.

In some embodiments, that when the computer-readable instruction is executed by one or more processor, the operation of training the sub-task network is implemented includes:
detecting whether a data dimension of input data is consistent with a preset input dimension, and detecting whether a data dimension of output data corresponding to the input data is consistent with a preset output dimension; and
in responding to that the data dimension of the input data is inconsistent with the preset input dimension and/or the data dimension of the output data corresponding to the input data is inconsistent with the preset output dimension, and interrupting training of the sub-task network.

Finally, it should be noted that a person skilled in the art may understand all or a part of the process of implementing the method in the embodiment above, which may be completed by using computer-readable instructions to instruct related hardware. The computer-readable instructions of the method for constructing the search framework of the neural network architecture may be stored in a computer-readable storage medium. When the computer-readable instructions are executed, the processes of the embodiments of the methods may be included. Wherein the non-volatile computer-readable storage media may be disk, disc, read-only memory (ROM) or random memory (RAM). The above embodiments of the computer-readable instructions may achieve the same or similar effects as any one of the corresponding method embodiments.

The above is an exemplary embodiment of the present disclosure, but it should be noted that various changes and modifications may be made without deviating from the scope disclosed by the embodiments of present disclosure, which is limited by the claim. The functions, steps and/or actions of the method claims according to the embodiment disclosed described here do not need to be performed in any particular order. In addition, although the elements disclosed in the embodiments of the present application may be described or required in an individual form, they may be understood as multiple unless explicitly limited to singular.

It should be understood that what is used herein, unless the context clearly supports exceptions, the singular form ‘one’ is intended to also include the plural form. It should also be understood that the ‘and/or’ used herein refers to any and all possible combinations of items that include one or more items listed in association.

That the above-mentioned embodiments of the present application disclose the serial number of the embodiments is only for description, not for the merits of the embodiments.

Ordinary technical persons in the art may understand that all or a part of the steps to implement the above embodiments may be completed by hardware, or by computer-readable instructions to instruct related hardware. Computer instructions may be stored in non-volatile computer-readable storage media. Non-volatile computer-readable storage media may be read-only memory, disk or disc and so on.

As used in the present application, the terms ‘component’, ‘module’ and ‘system’ are intended to denote computer-related entities, which may be hardware, combinations of hardware and software, software, or software in execution. For example, components may be, but are not limited to, processes, processors, objects, executable codes, executing threads, programs, and/or computers running on the processor. As an illustration, applications and servers running on the server may be components. One or more components may reside in processes and/or executing threads, and components may be located within a computer and/or distributed between two or more computers.

The ordinary technical persons in the art should understand that the discussion of any of the above embodiments is only illustrative and is not intended to imply that the scope disclosed by the embodiments of the present application (including claims) is limited to these examples; under the idea of the embodiments of the present application, the technical features of the above embodiments or different embodiments may also be combined, and there are many other changes in different aspects of the above embodiments of the present application, which are not provided in the details for simplicity. Therefore, any omissions, modifications, equivalent substitutions, improvements, etc. made within the spirit and principles of the embodiments of the present application shall be included in the scope of protection of the embodiments of the present application.

1. A method for constructing a search framework of a neural network architecture, comprising:
generating an initial super-network structure in a super-network class according to a search space configuration file, and pre-training a super-network in the initial super-network structure by using a data set;
sampling a sub-network in the pre-trained super-network by using a controller, and setting corresponding head network and neck network in the sub-network according to a task type to form a sub-task network;
training the sub-task network, and updating the initial super-network structure according to a training result to obtain the super-network structure; and
verifying the super-network structure based on a plurality of sub-task networks, and optimizing the super-network and the controller by using verification results, and repeating the processes of the controller of sampling, verifying and optimizing until the time of repetitions reaches a threshold, and selecting the super-network structure with an optimal verification result as the search framework of the neural network architecture.

2. The method according to claim 1, wherein the step of verifying the super-network structure based on the plurality of sub-task networks comprises:
sampling the plurality of sub-task networks, and stacking the plurality of sub-task networks according to a preset stacking mode to generate a backup network set, and verifying the super-network structure by using the backup network set.

3. The method according to claim 1, wherein the method further comprises:
determining a process of training the sub-task network is interrupted by an interrupt event, reading the super-network structure and parameters according to a preset address, and recovering a super-network weight and a number of training iterations.

4. The method according to claim 1, wherein the step of training the sub-task network comprises:
detecting whether a data dimension of input data is consistent with a preset input dimension, and detecting whether a data dimension of output data corresponding to the input data is consistent with a preset output dimension; and
in responding to that the data dimension of the input data is inconsistent with the preset input dimension and/or the data dimension of the output data corresponding to the input data is inconsistent with the preset output dimension, interrupting training of the sub-task network.

5-8. (canceled)

9. A computer device, comprising:
a memory storing computer-readable instructions therein; and
one or more processor configured for, when executing the computer-readable instructions, implementing operations comprising:
generating an initial super-network structure in a super-network class according to a search space configuration file, and pre-training a super-network in the initial super-network structure by using a data set;
sampling a sub-network in the pre-trained super-network by using a controller, and setting corresponding head network and neck network in the sub-network according to a task type to form a sub-task network;
training the sub-task network, and updating the initial super-network structure according to a training result to obtain the super-network structure; and
verifying the super-network structure based on a plurality of sub-task networks, and optimizing the super-network and the controller by using verification results, and repeating the processes of the controller of sampling, verifying and optimizing until the time of repetitions reaches a threshold, and selecting the super-network structure with an optimal verification result as the search framework of the neural network architecture.

10. One or more non-volatile computer-readable storage medium storing a computer-readable instruction, when the computer-readable instruction is executed by one or more processor, causing the processor to implement operations comprising:
generating an initial super-network structure in a super-network class according to a search space configuration file, and pre-training a super-network in the initial super-network structure by using a data set;
sampling a sub-network in the pre-trained super-network by using a controller, and setting corresponding head network and neck network in the sub-network according to a task type to form a sub-task network;
training the sub-task network, and updating the initial super-network structure according to a training result to obtain the super-network structure; and
verifying the super-network structure based on a plurality of sub-task networks, and optimizing the super-network and the controller by using verification results, and repeating the processes of the controller of sampling, verifying and optimizing until the time of repetitions reaches a threshold, and selecting the super-network structure with an optimal verification result as the search framework of the neural network architecture.

11. The computer device according to claim 9, wherein the operation of verifying the super-network structure based on the plurality of sub-task networks comprises:
sampling the plurality of sub-task networks, and stacking the plurality of sub-task networks according to a preset stacking mode to generate a backup network set, and verifying the super-network structure by using the backup network set.

12. The computer device according to claim 9, wherein the operations further comprise:
determining a process of training the sub-task network is interrupted by an interrupt event, reading the super-network structure and parameters according to a preset address, and recovering a super-network weight and a number of training iterations.

13. The computer device according to claim 9, wherein the operation of training the sub-task network comprises:
detecting whether a data dimension of input data is consistent with a preset input dimension, and detecting whether a data dimension of output data corresponding to the input data is consistent with a preset output dimension; and
in responding to that the data dimension of the input data is inconsistent with the preset input dimension and/or the data dimension of the output data corresponding to the input data is inconsistent with the preset output dimension, and interrupting training of the sub-task network.

14. The method according to claim 1, wherein the super-network structure is constructed by using a microscopic search method, the microscopic search method comprises:
obtaining a basic cell by searching;
realizing construction of the super-network by changing a stacking structure of the cell.

15. The method according to claim 14, wherein a search space inside the cell contains 6 alternative operations comprising: identity, convolution, dilated convolution, average pooling, max pooling and depthwise-separable convolution.

16. The method according to claim 1, wherein the method further comprises a saving progress and a recovering progress;
the saving progress comprises: outputting search configuration information, search task information, and result information to a result folder; receiving an instance of a model saving class, storing the super-network into the instance according to settings; storing a backup network set generated in a model-saving class instance after the backup network set run completely; and
the recovering progress comprises: according to user settings, reading the super-network according to a given address to realize the recovery of the super-network training progress; for an experiment, that has finished super-network training, prompting to restore the super-network or restore the backup network set, and restoring corresponding network parameters.

17. The method according to claim 1, wherein the method further comprises a fault-tolerant step, wherein the fault-tolerant step comprises:
determining whether the data dimension of the input data is consistent with an input dimension of model construction before inputting data;
selecting a data sample input model before inputting data, and verifying whether the data dimension of the output data is consistent with the assigned dimension; and
determining whether the data dimension of the output data generated by a sampler is within the sampling space before inputting data.

18. The method according to claim 17, wherein the fault-tolerant step further comprises:
when training the super-network, continuously updating a model_saver object, wherein the model_saver object saves checkpoints according to a time interval set by the user, to recover training when abnormal interruption occurs.

19. The computer device according to claim 9, wherein the super-network structure is constructed by using a microscopic search method, wherein the microscopic search method comprises:
obtaining a basic cell by searching;
realizing construction of the super-network by changing a stacking structure of the cell.

20. The computer device according to claim 19, wherein a search space inside the cell contains 6 alternative operations comprising: identity, convolution, dilated convolution, average pooling, max pooling and depthwise-separable convolution.

21. The computer device according to claim 9, wherein the operations further comprise a saving progress and a recovering progress;
the saving progress comprises: outputting search configuration information, search task information, and result information to a result folder; receiving an instance of a model saving class, storing the super-network into the instance according to settings; storing a backup network set generated in a model-saving class instance after the backup network set run completely; and
the recovering progress comprises: according to user settings, reading the super-network according to a given address to realize the recovery of the super-network training progress; for an experiment, that has finished super-network training, prompting to restore the super-network or restore the backup network set, and restoring corresponding network parameters.

22. The computer device according to claim 9, wherein the operations further comprise a fault-tolerant operation, wherein the fault-tolerant operation comprises:
determining whether the data dimension of the input data is consistent with an input dimension of model construction before inputting data;
selecting a data sample input model before inputting data, and verifying whether the data dimension of the output data is consistent with the assigned dimension; and
determining whether the data dimension of the output data generated by a sampler is within the sampling space before inputting data.

23. The computer device according to claim 22, wherein the fault-tolerant operation further comprises:
when training the super-network, continuously updating a model_saver object, wherein the model_saver object saves checkpoints according to a time interval set by the user, so as to recover training when abnormal interruption occurs.

24. The non-volatile computer-readable storage medium according to claim 10, wherein the operation of verifying the super-network structure based on the plurality of sub-task networks comprises:
sampling the plurality of sub-task networks, and stacking the plurality of sub-task networks according to a preset stacking mode to generate a backup network set, and verifying the super-network structure by using the backup network set.
